(19) United States
(12) Patent Application Publication
(10) Pub. No.: US 2011/0195685 A1
(43) Pub. Date: Aug. 11, 2011

(54) Detecting and Responding to Incidents

(75) Inventors: Steven Bridges, Roswell, GA (US); Michael Austin, Smyrna, GA (US)

(73) Assignee: IG PARTNERS, LLC, Atlanta, GA (US)

(21) Appl. No.: 12/700,817

(22) Filed: Feb. 5, 2010

(51) Int. Cl. H04M 11/04; H04M 3/42

(52) U.S. Cl. 455/404.1; 455/416

(57) ABSTRACT

Disclosed are various embodiments for detecting and responding to incidents. In at least one computing device, it is determined that an incident associated with a personal communication device has occurred. A conference including a plurality of conference participants is initiated. An escalation decision is obtained from at least one of the conference participants.

### BACKGROUND

Personal security may be a concern for people depending upon the situation. As an example, real estate agents may worry about their personal security when they are alone and showing a property to someone they have never met. As another example, a person may be worried about personal security when walking alone at night. In situations where people feel that their personal safety may be in jeopardy, they may carry a cellular telephone. People may intend to use the cellular telephone to call friends, family, and/or law enforcement when their personal safety is threatened.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of incident management environment according to various embodiments of the present disclosure.

FIGS. 2-5 are drawings of examples of user interfaces rendered by a client computing device in the incident management environment of FIG. 1 according to various embodiments of the present disclosure.

FIGS. 6 and 7 are flowcharts illustrating examples of functionality implemented as portions of an incident management application executed in a computing resource in the incident management environment of FIG. 1 according to various embodiments of the present disclosure.

FIG. 8 is a schematic block diagram that provides one example illustration of a computing resource employed in the incident management environment of FIG. 1 according to various embodiments of the present disclosure.

### DETAILED DESCRIPTION

Although individuals may carry cellular telephones and/or other personal communication devices in order to maintain personal security in potentially dangerous situations, cellular telephones by themselves may be inadequate to ensure personal security. When an emergency occurs, a user would have to pull out the cellular telephone, potentially from a pocket or a purse, and dial 911 or some other telephone number. Thereafter, the user would have to communicate his or her emergency to a person on the other end of the line. Substantial time may be incurred, and the emergency response may be delayed.

Additionally, if, for example, a person is being attacked or has a health emergency, the person may not be capable of performing the actions required to notify an emergency responder. It may be difficult to use the cellular telephone or even impossible, for example, if an attacker has thrown the cellular telephone away from the user. Depending upon the type of emergency, a person may not be capable of giving detailed information about the emergency over a cellular telephone. Although emergency services may be able to determine the location of a cellular telephone, merely ascertaining the location of the cellular telephone fails to provide important context about the user in relation to the activities of the user. For example, the user may know that he or she is in a potentially dangerous situation when meeting a new person for business, walking through a desolate area to get to a parking location, and/or in other situations. Furthermore, friends and family may be able to relate additional context and provide information to emergency responders when necessary.

The embodiments disclosed herein provide an incident detection and response system that can determine that an incident associated with a personal communication device, such as a cellular telephone, has occurred. In various embodiments, this determination may be made through a passive mode where a user sends a distress indication, or through an active mode where a user fails to respond to a status confirmation request automatically sent to his or her personal communication device. When the system determines that an incident has occurred, a conference may be initiated including one or more conference participants who may communicate with each other. The conference participants may be provided with critical information to enable them to decide whether to escalate the incident to notify emergency responders. In the following discussion, a general description of the system and its components is provided, followed by a discussion of the operation of the same.

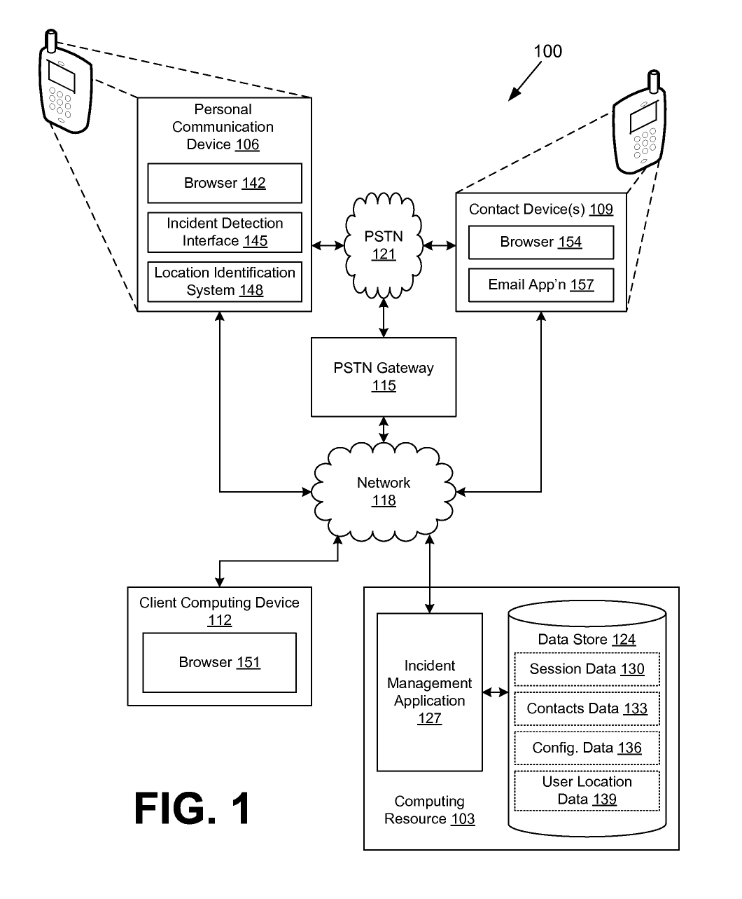

With reference to FIG. 1, shown is an incident management environment 100 according to various embodiments. The incident management environment 100 includes a computing resource 103 in data communication with a personal communication device 106, one or more contact devices 109, a client computing device 112, and a public switched telephone network (PSTN) gateway 115 by way of a network 118. The network 118 includes, for example, the Internet, intranets, extranets, wide area networks (WANs), local area networks (LANs), wired networks, wireless networks, or other suitable networks, etc., or any combination of two or more such networks. The PSTN gateway 115 communicates with the personal communication device 106 and the contact devices 109 by way of the PSTN 121. The PSTN 121 may include any type of telephone network such as a voice over Internet protocol (VoIP) network, a public land mobile network (PLMN), and/or any other type of communications network. The PSTN 121 may enable voice communication, short message service (SMS) communication, and/or any other type of analog or digital communication.

The computing resource 103 may comprise, for example, a server computer or any other computing device or system providing computing capability. The computing resource 103 may represent multiple computer systems arranged, for example, in one or more server banks or other arrangements. To this end, the computing resource 103 may comprise, for example, a cloud computing resource, a grid computing resource, and/or any other distributed computing arrangement. Such computer systems may be located in a single installation or may be dispersed among many different geographical locations. In one embodiment, the computing resource 103 represents a virtualized computer system executing on one or more physical computing systems. For purposes of convenience, the computing resource 103 is referred to herein in the singular. However, in one embodiment, the computing resource 103 represents a plurality of computer systems arranged as described above.

Various applications and/or other functionality may be executed in the computing resource 103 according to various embodiments. Also, various data is stored in a data store 124 that is accessible to the computing resource 103. The data store 124 may be representative of a plurality of data stores as can be appreciated. The data stored in the data store 124, for example, is associated with the operation of the various applications and/or functional entities described below.

The components executed on the computing resource 103, for example, include an incident management application 127 and other applications, services, processes, systems, engines, and/or functionality not discussed in detail herein. The incident management application 127 is executed to manage user sessions and configuration parameters, determine that incidents have occurred, initiate conferences regarding the incidents, escalate the incidents as necessary, and/or other actions related to incident detection and response.

The data stored in the data store 124 includes, for example, session data 130, contacts data 133, configuration data 136, user location data 139, and/or potentially other data. The session data 130 includes parameters and other data related to various on-going sessions related to personal communication devices 106. The contacts data 133 may include data describing various people to contact when an incident has been detected. To this end, contacts data 133 may include, for example, names, telephone numbers, email addresses, physical addresses, a description of the relationship to the user, and/or other information.

The configuration data 136 may include parameters for the incident management application 127 that may be configured for a user. As a non-limiting example, configuration data 136 may configure potential escalation actions to be taken when an incident has been detected. Further, the configuration data 136 may include messages recorded by the user to be played during conference calls with contacts, personalized messages to be included within email communications to contacts, and/or other configuration information.

The user location data 139 may include locations associated with a user of the personal communication device 106 as obtained from the personal communication device 106 when it is being actively monitored. As a non-limiting example, the user location data 139 may include location coordinates, postal codes, street addresses, and/or other location identifiers that may be associated with a personal communication device 106.

The personal communication device 106 is representative of a plurality of personal communication devices 106 that may be coupled to the network 118 and the PSTN 121. In some embodiments, the personal communication device 106 may comprise, for example, a processor-based system such as a computer system. Such a computer system may be embodied in the form of a cellular telephone, a laptop computer, a desktop computer, a personal digital assistant, a set-top box, a music player, a web pad, a tablet computer system, or other devices with like capability. In other embodiments, a personal communication device 106 may comprise merely a wired or cellular telephone with at least basic voice communication functionality.

Where the personal communication device 106 comprises a processor-based system, the personal communication device 106 may be configured to execute various applications such as a browser 142, an incident detection interface 145, a location identification system 148, and/or other applications. The personal communication device 106 may be configured to execute applications beyond browser 142, incident detection interface 145, and the location identification system 148 such as, for example, email applications, instant message applications, and/or other applications. The browser 142 may be executed in the personal communication device 106, for example, to access and render network pages, such as web pages, and/or other network content served up by the computing resource 103 or other servers.

The incident detection interface 145 may include code that enables a user to provide a distress indication through the personal communication device 106. The incident detection interface 145 may also include code that facilitates an active mode of incident detection, for example, by scheduling status confirmation requests within the personal communication device 106. The incident detection interface 145 may be configured to communicate with the incident management application 127 in order to report the detection of an incident. Where the personal communication device 106 has only basic voice communication functionality, the incident detection interface 145 may represent, as a non-limiting example, an interface to the voice channel whereby the user may answer to respond to a status confirmation request.

In some embodiments, the personal communication device 106 includes a location identification system 148 that is configured to identify the current location associated with the personal communication device 106. To this end, the location identification system 148 may be configured to determine current coordinates of the personal communication device 106, for example, through the global positioning system (GPS) and/or another system. Alternatively, or additionally, the location identification system 148 may enable, for example, triangulation of the current location of the personal communication device 106 based upon locations of several fixed communication towers. In various embodiments, portions of the location identification system 148 associated with a particular personal communication device 106 may be executing on an external computing resource associated with the PSTN 121.

The client computing device 112 is representative of a plurality of client devices that may be coupled to the network 118. The client computing device 112 may comprise, for example, a processor-based system such as a computer system. Such a computer system may be embodied in the form of a desktop computer, a laptop computer, a personal digital assistant, a cellular telephone, set-top box, music players, web pads, tablet computer systems, or other devices with like capability.

The client computing device 112 may be configured to execute various applications such as a browser 151 and/or other applications. The browser 151 may be executed in a client computing device 112, for example, to access and render network pages, such as web pages, or other network content served up by the computing resource 103 and/or other servers. The client computing device 112 may be configured to execute applications beyond browser 151 such as, for example, email applications, instant message applications, and/or other applications.

The contact device 109 is representative of a plurality of contact devices that may be coupled to the PSTN 121 and/or the network 118. In some embodiments, the contact device 109 may comprise, for example, a processor-based system such as a computer system. Such a computer system may be embodied in the form of a cellular telephone, a smart phone, a desk top computer, a laptop computer, a personal digital assistant, a set top box, music players, web pads, tablet computer systems, or other devices with like capability. In other embodiments, a contact device 109 may comprise merely a telephone with no additional functionality. In various embodiments, a contact device 109 may represent a combination of a cellular telephone and one or more separate computer systems.

The contact device 109 may be configured to execute various applications such as a browser 154, an email application 157, and/or other applications. The browser 154 may be executed in a contact device 109, for example, to access and render network pages, such as web pages, or other network content served up by the computing resource 103 and/or other servers. The contact device 109 may be configured to execute applications beyond browser 154 and email application 157 such as, for example, instant message applications and/or other applications.

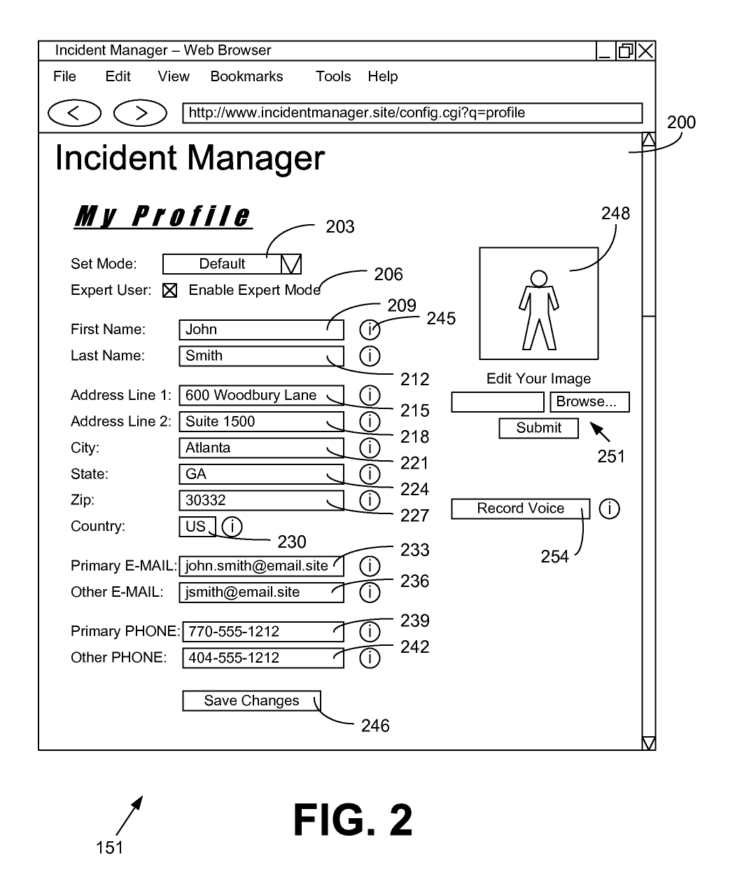

Next, a general description of the operation of the various components of the incident management environment 100 is provided. To begin, a user associated with a personal communication device 106 configures an account with the incident management application 127 by using the browser 151 of the client computing device 112. Alternatively, the user may use the browser 142 of the personal communication device 106, where a browser 142 executes on the personal communication device 106. The discussion that follows describes examples of user interfaces as illustrated in FIGS. 2-5 that may be used to configure an account.

Turning now to FIG. 2, shown is a drawing of an example of a user interface rendered by a browser 151 when configuring an account for the user. The user interface comprises a network page 200 entitled “My Profile.” The network page 200 may include a mode setting 203, which is pictured in this non-limiting example as a drop-down box. A user may configure one or more modes and select which of the modes may be activated at a given time depending on the circumstances.

As non-limiting examples, a user may configure a home mode for use when the user is at home, a commuting mode for use when traveling to and from work, a default mode to be used when no other mode is activated, a high security mode when the user is afraid for his or her safety, and/or other types of modes with their own settings. Each mode may configure settings such as when and how often a status confirmation request is sent to the personal communications device 106, how long to wait for a status confirmation before determining that an incident has occurred, which contacts should be notified when an incident is detected, which escalation actions are applicable to an incident, etc. The network page 200 may include an expert mode option 206, illustrated as a checkbox, which may provide a simpler interface to the user for configuring a session of incident detection.

The network page 200 may allow the user to specify a first name 209, a last name 212, a first address line 215, a second address line 218, a city 221, a state 224, a zip code 227, a country 230, and/or other personally identifying information. The network page 200 may allow the user to specify contact information such as a primary email 233, a secondary email 236, a primary phone number 239, a secondary phone number 242, and/or other contact information. Any of the user interface elements depicted in network page 200 may be accompanied by an information tool 245 that, when selected, provides information about the user interface element. Such information may include help regarding that user interface element, examples of properly completing a text entry, if applicable, and/or other information. The network page 200 may include a save button 246 that enables changes to the displayed data to be sent to the incident management application 127 (FIG. 1) and saved in the data store 124 (FIG. 1).

The network page 200 may include a profile image 248, which may be modified through an image modification means 251. The profile image 248 may represent information that may be provided by the incident management application 127 to an emergency responder at a contact device 109 (FIG. 1) when an incident is escalated. The network page 200 may provide an option for the user to select a record button 254 for the user to record a sample of his or her voice. The user may be able to record messages for use with the system through the network page 200. The personal communication device 106 (FIG. 1), if so equipped, may be configured to record additional sounds, images, and/or video and provide such additional sounds, images, and/or video to an emergency responder at a contact device 109 when an incident is escalated.

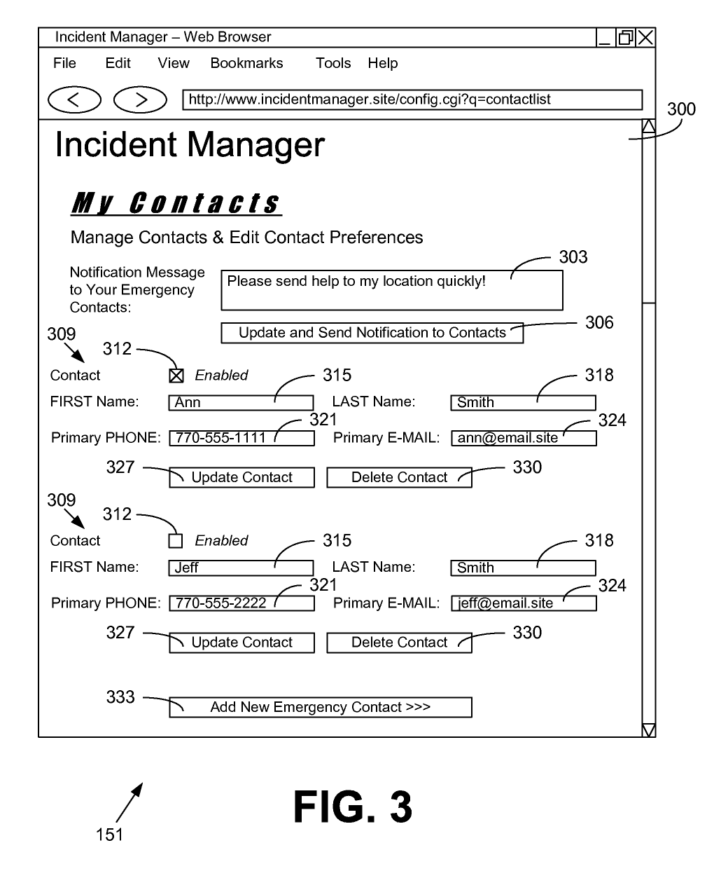

Referring next to FIG. 3, shown is a drawing of another example of a user interface rendered by a browser 151. The user interface comprises network page 300 entitled “My Contacts.” The network page 300 enables a user to manage a list of contacts, which may be maintained in the contacts data 133 (FIG. 1) of the data store 124 (FIG. 1). The network page 300 may include a notification message field 303, which allows the user to specify a message that is provided to the contacts when an incident is detected. The notification message may be updated by selecting an update notification button 306, which may be configured to send a notification to the contacts and/or update data in the data store 124.

Network page 300 includes one or more contacts 309 that may be managed using various user interface components. Each contact 309 may have an enabled selector 312 (for example, a check box, radio button, and/or other type of button) to determine whether that particular contact 309 will be included as an active contact within the list of contacts as needed. The user may specify a first name 315, a last name 318, a primary phone 321, a primary email 324, and/or other information as appropriate. Each contact 309 may have an update button 327 and a delete button 330 to update or delete the contact 309, respectively. In addition, the network page 300 may include an add contact button 333 in order to add a new contact 309 to a list of contacts.

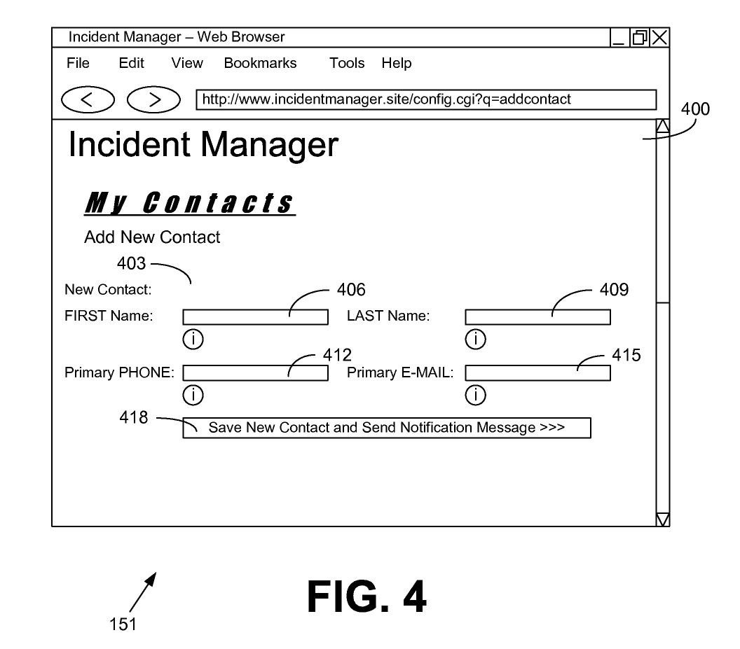

Moving on to FIG. 4, shown is a drawing of another example of a user interface rendered by a browser 151. The user interface comprises a network page 400 entitled “My Contacts.” In various embodiments, the network page 400 may be included with in the network page 300 (FIG. 3) or may comprise an entirely separate network page 400 as depicted in FIG. 4. Network page 400 enables a user to add a new contact to the system. To this end, network page 400 may include user interface elements enabling the user to specify information about the new contact.

The network page 400 may include an enabled button 403 to determine whether the new contact will be enabled or disabled when created. The network page 400 may allow a user to specify a first name 406, a last name 409, a primary phone number 412, a primary email address 415, and/or other information about a contact. The network page 400 may include a save button 418 to enable the user to save the new contact and/or send a notification message to that contact, if necessary.

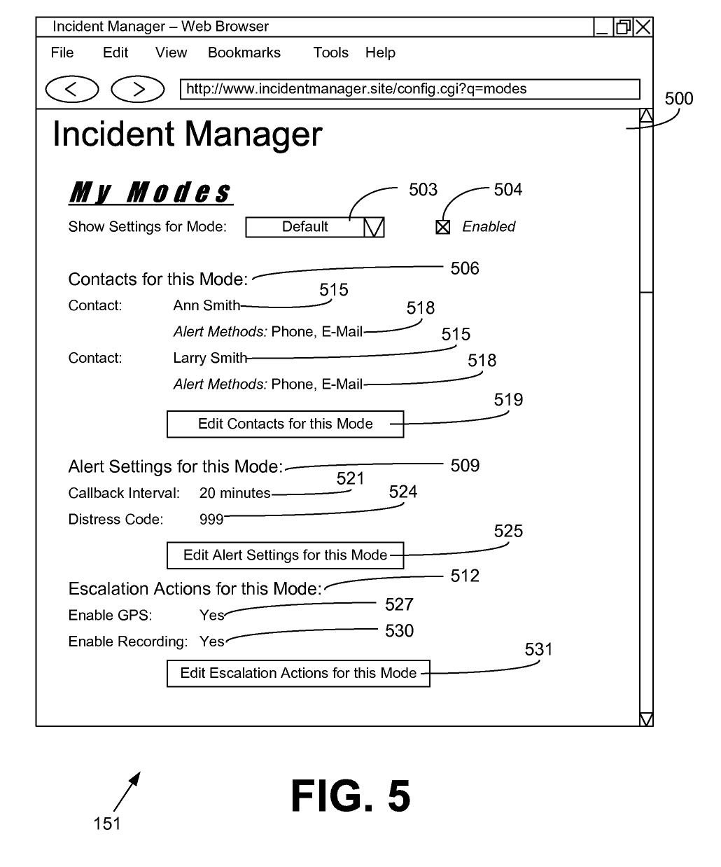

With reference now to FIG. 5, shown is a drawing of another example of a user interface rendered by a browser 151. A user interface comprises a network page 500 entitled “My Modes.” The network page 500 enables the user to view the current settings for a particular mode. The current mode may be selectable by way of a mode selector 503, which is shown in this non-limiting example as a drop-down box. The selected mode may be enabled or disabled for a current session, for example, by use of an enabled checkbox 504. In other embodiments, a current session may be enabled for a selected mode by placing a telephone call, sending a text message, sending an email, pressing configurable buttons or a sequence of buttons on a phone, and/or by some other action. In one embodiment, a session for a particular mode may be enabled automatically based on the geographic location of the user. The network page 500 may also allow for editing times or intervals at which a session for the selected mode is to be enabled or disabled.

The network page 500 may include a list of contacts 506, alert settings 509, escalation actions 512, and/or other configurable features related to a mode. The list of contacts 506 includes the contact name 515 and alert methods 518 applicable to the particular contact. An edit feature 519 may be provided to edit the list of contacts that applies to the selected mode. The alert settings 509 may enable a user to configure a call back interval 521, a distress code 524, and/or other alert settings 509. An edit feature 525 may be provided to edit the alert settings that apply to the selected mode.

The escalation actions 512 may enable a user to configure a GPS status 527, a recording status 530, and/or other settings applicable to the mode. The GPS status 527 may enable GPS location identification features of the personal communication device 106 (FIG. 1). In one embodiment, the GPS status 527 may also enable automatic initiation of sessions and/or determination of a mode of operation based on the location of the user. The recording status 530 may enable automatic sound, image, and/or video recording features of the personal communication device 106. The recording status 530 may be configurable with parameters such as when to record automatically relative to the detection of incidents. In various embodiments, the escalation actions 512 may define contacts to be used when an incident is escalated such as, for example, law enforcement, emergency responders, friends, family, co-workers, school authorities, consular authorities, etc. An edit feature 531 may be provided to edit the escalation actions that apply to the selected mode. The network page 500, in various embodiments, may allow configuration of the settings shown in FIG. 5 through a same network page 500 or a different network page 500.

Now referring back to FIG. 1, after the client computing device 112 has configured an account for a user at a personal communication device 106, a user configures and/or enables a session for incident detection and response. In various embodiments, this configuration may be performed by way of browser 142, incident detection interface 145, or some other interface. As non-limiting examples, a user may send a text message, make a call to a designated telephone number, press a combination of buttons on the personal communication device 106, press a specially configured button on the personal communication device 106, and/or take some other action. In various embodiments, the user may configure the session to become enabled at some time in the future. The user may also be able to specify ending times for the session and repeat intervals for the session, among other session settings.

In one embodiment, the mode and or other parameters for the session may be determined based at least in part on the location of the personal communication device 106 provided by the location identification system 148. In one embodiment, a session may be activated automatically when a user enters a predefined geographic area and deactivated automatically when the user leaves the area. As a non-limiting example, a user may have defined a work mode to be applied when the user is near an office. Such a work mode may initiate a session automatically when the user is near the office. Further, the work mode might define a different set of contacts (e.g., primarily co-workers) and/or actions to take upon escalation of an incident when compared to other modes.

When the user has selected a passive monitoring mode, the incident management application 127 waits to obtain a distress indication from the personal communication device 106. The distress indication may be sent by the user pressing a panic button, keying in a predefined distress code, dropping the personal communication device 106 (for example, where an accelerometer is included within the personal communication device 106 and is configured to detect such a dropping action), and/or providing any other input that may be correlated with an indication of distress.

When the user has selected an active monitoring mode, the incident management application 127 may send a status confirmation request to the personal communication device 106 by way of the network 118 and/or the network 118 in conjunction with the PSTN gateway 115 and the PSTN 121. A status confirmation request may comprise a telephone call, a text message, an email, and/or any other communication that may take the form of a status confirmation request. In various embodiments, the personal communication device 106 may be itself configured to originate status confirmation requests. The status confirmation requests may be generated according to a predefined schedule. As a non-limiting example, a user may configure a session such that a status confirmation request is sent to the personal communication device every five minutes, ten minutes, twenty minutes, or at some other time interval.

Ordinarily, when no emergency is occurring, the user will receive the status confirmation request and reply to the incident management application 127 with a status confirmation. The status confirmation may include, for example, entering in a code using the personal communication device 106, answering a phone call from the incident management application 127, speaking into the personal communication device 106, sending a text message, accessing a network site, engaging in a biometric identification, and/or taking some other action to authenticate the safety of the user. However, when no status confirmation is received for a predetermined time (which may be user configurable) after sending the status confirmation request, the incident management application 127 may then conclude that an incident associated with the personal communication device 106 and the user has occurred. In some embodiments, the incident management application 127 may resend the status confirmation request a number of times before concluding that an incident has occurred.

When the incident management application 127 determines that an incident associated with the personal communication device 106 has occurred, either by passive mode or by active mode, the incident management application 127 initiates a conference call including one or more conference participants according to a list of contacts defined by the user in contacts data 133. The list of contacts used to start the conference may depend on the mode, the geographic location of the user, and/or other factors. As a non-limiting example, the incident management application 127 may immediately begin dialing telephone numbers provided within the list of contacts and joining the calls together within a conference call. The incident management application 127 may contact the contact devices 109 corresponding to the list of contacts by way of the PSTN 121 or by the network 118. The contact devices 109 may be joined to the conference simultaneously or successively as desired. The incident management application 127 may be configured to contact various contacts repeatedly and/or at alternate contact devices 109 as desired.

In various embodiments, the conference may enable voice communication between each of the conference participants at the respective contact devices 109. In various embodiments, initiating a conference may comprise sending an electronic communication, such as an email, to each of the contact participants at the respective contact devices 109. In such a case, the conference participants may then connect into a conference according to information provided in the electronic communication. Alternatively, a conference may be maintained over the network 118 using text communication.

In various embodiments, one or more of the conference participants may send a termination request to the incident management application 127 that terminates the conference. A user associated with a personal communication device 106 may prefer to be included within the list of contacts. Thus, in various embodiments, the user may have an opportunity to terminate the conference when it results from a false alarm. In some situations, other conference participants may be able to determine from information provided during the conference that the incident resulted from a false alarm and then terminate the conference accordingly. When a conference has been terminated, the incident management application 127 may be configured to cease joining other participants into the conference.

During the conference, the incident management application 127 may provide information regarding the incident to the conference. This information may include, for example, a predefined message created by the user associated with the personal communication device 106. Such a predefined message may comprise a sound recording of the user created either through the client computing device 112 or the personal communication device 106. Alternatively, the message may comprise a text message which may be converted, using a text-to-speech converter, so that it may be played during the conference. In addition, the incident management application 127 may send such a text message, for example, by email to the respective contact devices 109. The message may be created by the user in order to provide context relating to the conference. As a non-limiting example, the user may describe the circumstances relating to a current session such as, for example, a description an activity the user had planed to engage in during the session and/or some other description.

The incident management application 127 may be configured to communicate the predefined message to the conference, for example, when each conference participant joins the conference. Alternatively, the incident management application 127 may communicate the predefined message once all participants have joined the conference. Additionally, the incident management application 127 may communicate the predefined message to the conference when requested by one or more of the conference participants. As a non-limiting example, the incident management application 127 may provide a menu to the conference such that a conference participant may dial a number to play or replay the predefined message.

The incident management application 127 may provide other information to the conference participants, including, for example, one or more locations associated with the personal communication device 106. To this end, the incident management application 127 may generate and send a map to the conference participants, for example, by email or some other method. The map may depict a plurality of locations associated with the personal communication device 106. As a non-limiting example, the map may include a graphical push pin at each location of the personal communication device 106, thereby allowing the conference participants to estimate the movement of the personal communication device 106 over time during the session. It is understood that the incident management application 127 may provide other types of information to the conference participants, including, but not limited to, audio, video, and still images sent from the personal communication device 106.

During the conference, the conference participants at the respective contact devices 109 may communicate with each other to determine a course of action for responding to the incident. If one or more conference participants believe the incident is merely a false alarm, the conference participants may decide to do nothing. If, instead, the conference participants believe that the user at the personal communication device 106 is indeed in danger or otherwise in an emergency situation, one or more of the conference participants may decide to escalate the incident. By escalating the incident, the conference participants instruct the incident management application 127 to perform one or more escalation actions in response to the escalation decision. Such an escalation action may comprise notifying one or more emergency responders, parents, friends, school authorities, consular authorities, and/or others that may be able to respond to the incident.

In escalating the incident, a conference participant may select an escalation action from a list of escalation actions defined by the user associated with the personal communication device 106. Moreover, the list of escalation actions may be selected by the incident management application 127 from a plurality of lists of escalation actions according to a current mode configured by the user. Furthermore, the escalation actions may depend upon a last location associated with the personal communication device 106. In this way, geographically appropriate emergency responders may be notified.

In various embodiments, the incident management application 127 may connect one or more of the contact devices 109 to another contact device 109 associated with an emergency responder or some other contact defined by the escalation action. In other words, the emergency responder or some other contact may be joined to the conference as a conference participant. Accordingly, the conference participants may provide information that they know to the emergency responders or other contacts to be notified. Further, the incident management application 127 may be configured to provide information to the escalation contact, which may include, but is not limited to, a photo of the user, a predefined message from the user, one or more locations of the personal communication device, audio, video, and/or still images recorded by the personal communication device 106, etc.

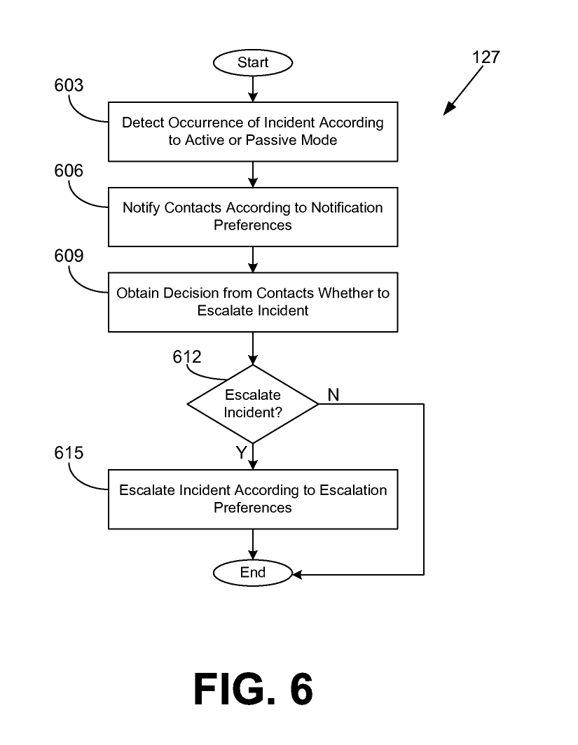

Referring next to FIG. 6, shown is a flowchart that provides one example of the operation of a portion of the incident management application 127 according to various embodiments. It is understood that the flowchart of FIG. 6 provides merely an example of the many different types of functional arrangements that may be employed to implement the operation of the portion of the incident management application 127 as described herein. As an alternative, the flowchart of FIG. 6 may be viewed as depicting an example of steps of a method implemented in the computing resource 103 (FIG. 1) according to one or more embodiments.

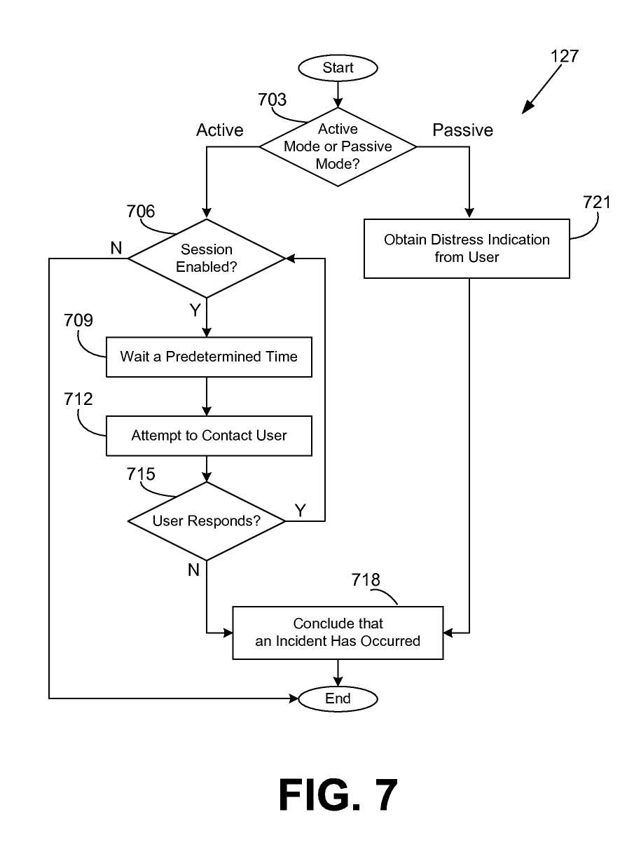

Beginning with box 603, the incident management application 127 detects an occurrence of an incident according to an active or passive mode. More detail regarding the logic of box 603 may be seen in the flowchart of FIG. 7. Next, in box 606, the incident management application 127 notifies one or more contacts according to notification preferences such as, for example, a list of contacts in contacts data 133 and parameters stored in configuration data 136.

In box 609, the incident management application 127 obtains a decision from the contacts whether to escalate the incident. In various embodiments, the incident management application 127 may place the contacts at contact devices 109 together in a conference so that the various contacts may communicate with each other. In box 612, the incident management application 127 determines whether the incident is to be escalated.

If, in box 612, the incident management application 127 determines that the incident is to be escalated, the incident management application 127 escalates the incident according to escalation preferences of the user. Such preferences may be stored, for example, the configuration data 136. The escalation may involve, for example, performing one or more escalation actions such as contacting emergency responders, friends, family, school authorities, consular authorities, etc. Thereafter, the incident management application 127 ends.

If, instead, in box 612, the incident management application 127 determines that the incident in not to be escalated (for example, when the contacts determine that the incident represents a false alarm), the incident management application 127 ends.

With reference to FIG. 7, shown is a flowchart that provides another example of the operation of a portion of the incident management application 127 according to various embodiments. Specifically, the flowchart of FIG. 7 provides more detail regarding logic associated with box 603 of the flowchart of FIG. 6. It is understood that the flowchart of FIG. 7 provides merely an example of the many different types of functional arrangements that may be employed to implement the operation of the portion of the incident management application 127 as described herein. As an alternative, the flowchart of FIG. 7 may be viewed as depicting an example of steps of a method implemented in the computing resource 103 (FIG. 1) according to one or more embodiments.

Beginning with box 703, the incident management application 127 determines whether an active mode or a passive incident detection mode is enabled. If, in box 703, the incident management application 127 determines that an active mode is selected, the incident management application 127 proceeds to box 706 and determines whether a session is currently enabled. If, in box 706, the incident management application 127 determines that a session is not enabled, the portion of the incident management application 127 concludes that an incident has not occurred and ends.

If, instead, in box 706, the incident management application 127 determines that a session is enabled, the incident management application 127 proceeds to box 709 and waits a predetermined time. Subsequently, in box 712, the incident management application 127 attempts to contact the user at the personal communication device 106 (FIG. 1) by way of a status confirmation request. In box 715, the incident management application 127 determines whether the user responds to the contact attempt from box 712 with a status confirmation. If the user responds with a status confirmation, the incident management application 127 returns to box 706 and the control flow repeats.

If, instead, in box 715, the incident management application 127 determines that the user has not responded with a status confirmation, the incident management application 127 moves to box 718 and concludes that an incident has occurred. Thereafter, the portion of the incident management application 127 ends.

If, instead, in box 703, the incident management application 127 determines that a passive mode is in use, the incident management application 127 proceeds to box 721 and obtains a distress indication from the user at the personal communication device 106. Next, in box 718, in response to the distress indication, the incident management application 127 concludes that an incident has occurred. Thereafter, the portion of the incident management application 127 ends.

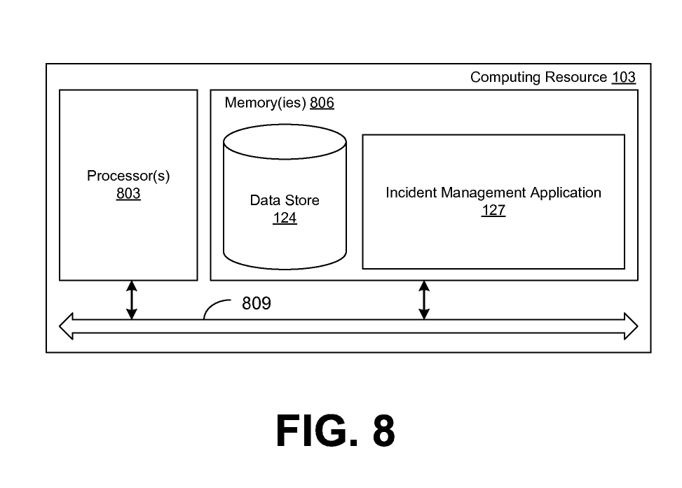

With reference to FIG. 8, shown is a schematic block diagram of the computing resource 103 according to an embodiment of the present disclosure. The computing resource 103 includes at least one processor circuit, for example, having a processor 803 and a memory 806, both of which are coupled to a local interface 809. To this end, the computing resource 103 may comprise, for example, at least one server computer or like device. The local interface 809 may comprise, for example, a data bus with an accompanying address/control bus or other bus structure as can be appreciated.

Stored in the memory 806 are both data and several components that are executable by the processor 803. In particular, stored in the memory 806 and executable by the processor 803 are the incident management application 127, and potentially other applications. Also stored in the memory 806 may be a data store 124 and other data. In addition, an operating system may be stored in the memory 806 and executable by the processor 803.

It is understood that there may be other applications that are stored in the memory 806 and are executable by the processors 803 as can be appreciated. Where any component discussed herein is implemented in the form of software, any one of a number of programming languages may be employed such as, for example, C, C++, C#, Objective C, Java, Java Script, Perl, PHP, Visual Basic, Python, Ruby, Delphi, Flash, or other programming languages.

A number of software components are stored in the memory 806 and are executable by the processor 803. In this respect, the term “executable” means a program file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and the memory 806 may represent multiple memories 806 that operate in parallel processing circuits, respectively. In such a case, the local interface 809 may be an appropriate network 118 (FIG. 1) that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the incident management application 127, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 6 and 7 show the functionality and operation of an implementation of portions of the incident management application 127. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each block may represent a circuit or a number of interconnected circuits to implement the specified logical function(s).

Although the flowcharts of FIGS. 6 and 7 show a specific order of execution, it is understood that the order of execution may differ from that which is depicted. For example, the order of execution of two or more blocks may be scrambled relative to the order shown. Also, two or more blocks shown in succession in FIGS. 6 and 7 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the incident management application 127, that comprises software or code can be embodied in any computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system.

In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
at least one computing device; and
an incident management application executable in the at least one computing device, the incident management application comprising:
logic that determines that an incident associated with a personal communication device has occurred;
logic that initiates a conference including a plurality of conference participants; and
logic that obtains an escalation decision from at least one of the conference participants.

2. The system of claim 1, wherein the conference participants are selected from a list of contacts defined by a user associated with the personal communication device.

3. The system of claim 2, wherein the list of contacts includes the user.

4. The system of claim 1, wherein the conference enables voice communication between each of the conference participants.

5. The system of claim 1, wherein the logic that initiates the conference further comprises logic that places a telephone call to a telephone number associated with each of the conference participants.

6. The system of claim 1, wherein the logic that initiates a conference further comprises logic that sends an electronic communication to each of the conference participants.

7. The system of claim 1, further comprising logic that provides information regarding the incident to the conference.

8. The system of claim 7, wherein the information includes a location associated with the personal communication device.

9. The system of claim 7, wherein the logic that provides information further comprises logic that sends a map to the conference participants, the map including a plurality of locations associated with the personal communication device.

10. The system of claim 7, wherein the information includes a predefined message created by a user associated with the personal communication device.

11. The system of claim 10, further comprising logic that communicates the predefined message to the conference when a new conference participant joins the conference.

12. The system of claim 10, further comprising logic that communicates the predefined message to the conference when requested by at least one of the conference participants.

13. The system of claim 1, wherein the logic that determines that an incident associated with a personal communication device has occurred further comprises logic that obtains a distress indication from the personal communication device.

14. The system of claim 1, wherein the logic that determines that an incident associated with a personal communication device has occurred further comprises:
logic that sends a status confirmation request to the personal communication device; and
logic that determines that the incident has occurred when no status confirmation is obtained from the personal communication device for a predetermined time after sending the status confirmation request.

15. A method, comprising:
determining, in at least one computing device, that an incident associated with a personal communication device has occurred;
initiating, in the at least one computing device, a conference including a plurality of conference participants; and
obtaining, in the at least one computing device, an escalation decision from at least one of the conference participants.

16. The method of claim 15, wherein the step of determining that an incident associated with a personal communication device has occurred further comprises the steps of:
sending a status confirmation request to the personal communication device according to a predefined schedule; and
determining that the incident has occurred when no status confirmation is obtained from the personal communication device for a predetermined time after sending the status confirmation request.

17. The method of claim 15, wherein the conference participants are joined to the conference according to a list of contacts defined by a user associated with the personal communication device.

18. The method of claim 17, wherein the list of contacts includes the user, and the method further comprises the step of terminating the conference responsive to a termination request obtained from the user.

19. The method of claim 15, further comprising the step of performing an escalation action in response to the escalation decision.

20. The method of claim 19, wherein the escalation action comprises notifying at least one emergency responder.

21. The method of claim 19, wherein the escalation decision selects the escalation action from a list of escalation actions defined by a user associated with the personal communication device.

22. The method of claim 21, wherein the list of escalation actions is selected from a plurality of lists of escalation actions according to a current mode configured by the user.

23. A system, comprising:
means for determining, in at least one computing device, that an incident associated with a personal communication device has occurred;
means for initiating, in the at least one computing device, a conference including a plurality of conference participants; and
means for obtaining, in the at least one computing device, an escalation decision from at least one of the conference participants.
